(19) United States
(12) Patent Application Publication
(10) Pub. No.: US 2015/0178651 A1
(43) Pub. Date: Jun. 25, 2015

(54) SUPPLY CHAIN RISK ASSESSMENT

(71) Applicant: International Business Machines Corporation, Armonk, NY (US)

(72) Inventors: Hans-Juergen Eickelmann, Nieder-Hilbersheim (DE); Glenn C. Godoy, Endicott, NY (US); Chester Dennis Karwatowski, West Shokan, NY (US); Ruediger Kellmann, Mainz (DE); Wai Mon Ma, POUGHKEEPSIE, NY (US); Karen Nan Toger, Wake Forest, NC (US)

(73) Assignee: International Business Machines Corporation, Armonk, NY (US)

(21) Appl. No.: 14/135,218

(22) Filed: Dec. 19, 2013

(51) Int. Cl. G06Q 10/06

(52) U.S. Cl. CPC G06Q 10/06315

(57) ABSTRACT

Disclosed is an apparatus that includes an identifying module, a survey module, an analytics module, and a ranking module. The identifying module identifies selected users, wherein the selected users are those users that have an awareness of factors that potentially affect a supply chain. The survey module administers a supply chain screening survey, which includes groups of intercorrelated questions, to the selected users and receives survey answers from the selected users. The analytics module performs a modified Cronbach-alpha analysis on the survey answers from the selected users in order to generate a response consistency rating for each of the selected users. The modified Cronbach-alpha analysis includes determining, for each one of the selected users, consistency between selected users of the survey answers within each group of intercorrelated questions. The ranking module assigns a reliability rank to each of the selected users based on their response consistency rating.

### FIELD

The subject matter disclosed herein relates to supply chain risk assessment and more particularly relates to reliably assessing risk to a supply chain using crowd sourcing.

### BACKGROUND

Assessing risks to a supply chain and managing those risks are important practices for many businesses. A supply chain is a system of resources (e.g., people, companies, activities, processes, equipment) that are involved with supplying a customer with a product or a service. In order to maintain a functioning supply chain, events and circumstances are often assessed in order to determine if the events and circumstances pose a risk to the supply chain. In other words, supply chain risk assessment involves an analysis of how potential risks may affect a system of resources in a supply chain and what preventative and/or remedial actions can be performed in order to reduce vulnerability and ensure supply chain continuity.

### BRIEF SUMMARY

The present disclosure relates to an apparatus that includes an identifying module, a survey module, an analytics module, and a ranking module. In one embodiment, at least a portion of the identifying module, the survey module, the analytics module, and the ranking module include one or more of hardware and executable code, the executable code stored on one or more computer readable storage media. According to one embodiment, the identifying module identifies selected users. The selected users are those users that have an awareness of factors that potentially affect a supply chain. In one embodiment, the survey module administers a supply chain screening survey to the selected users and receives survey answers from the selected users. The supply chain screening survey includes groups of intercorrelated questions. In one embodiment, the analytics module performs a modified Cronbach-alpha analysis on the survey answers from the selected users in order to generate a response consistency rating for each of the selected users. The modified Cronbach-alpha analysis includes determining, for each one of the selected users, consistency for each of the selected users of the survey answers within each group of intercorrelated questions. The ranking module, according to one embodiment, assigns a reliability rank to each of the selected users based on their response consistency rating.

In one implementation, the apparatus further includes a user communication module that communicates with knowledgeable users of the selected users in order to generate a supply chain risk report from each of the knowledgeable users. The knowledgeable users have a specific knowledge of circumstances that are potentially affecting the supply chain. Also, the apparatus may further include a supply chain risk assessment module that receives the supply chain risk report from each of the knowledgeable users and generates a supply chain risk assessment by weighing the supply chain risk report from each of the knowledgeable users with the reliability ranking assigned to each of the knowledgeable users.

In one embodiment, the user communication module communicates with the knowledgeable users via a social media application. In another embodiment, the knowledgeable users are the selected users with a comparatively higher reliability rank. According to another embodiment, the specific knowledge of the knowledgeable users is physical proximity to the circumstances that are potentially affecting the supply chain.

According to one example, the supply chain risk assessment generated by the supply chain risk assessment module is a recommendation regarding a course of action to take in order to sustain the supply chain. In one embodiment, the selected users are employees of a company. In one embodiment, the supply chain screening survey is administered via a social media application. Further, the groups of intercorrelated questions may have the following topics, among others: awareness of factors that potentially affect a supply chain, degree of control over factors that potentially affect a supply chain, and awareness of how potential factors can affect a supply chain.

In one implementation, the modified Cronbach-alpha analysis includes determining the statistical variance of the survey answers from each selected user for each group of intercorrelated questions. In another implementation, the response consistency rating for each selected user is an average of the statistical variances from the groups of intercorrelated questions. In yet another embodiment, the response consistency rating is a percentage of questions answered consistently for each group of intercorrelated questions or an average percentage of questions answered consistently. In another embodiment, the reliability rank is a classification as either reliable or unreliable or the reliability rank may be a relative position in a listing of the selected users and the relative position is based on the response consistency rating of each of the selected users.

The present disclosure also relates to a method that includes identifying selected users that have an awareness of factors that potentially affect a supply chain, administering a supply chain screening survey to the selected users. The supply chain screening survey includes groups of intercorrelated questions. The method may further include receiving survey answers from the selected users and performing a modified Cronbach-alpha analysis on the survey answers from the selected users in order to generate a response consistency rating for each of the selected users. The modified Cronbach-alpha analysis includes determining, for each one of the selected users, consistency between selected users of the survey answers within each group of intercorrelated questions. The method includes assigning a reliability rank to each of the selected users based on the response consistency ratings for each of the selected users.

In one embodiment, identifying selected users is performed via a social media application. In another embodiment, the method further includes communicating with knowledgeable users from the selected users in order to generate a supply chain risk report from the knowledgeable users. The knowledgeable users are those users that have a specific knowledge of circumstances that are potentially affecting the supply chain. The method may, according to one embodiment, further include generating a supply chain risk assessment by weighing the supply chain risk report from each of the knowledgeable users with the reliability ranking assigned to each of the knowledgeable users. Also, the method may include soliciting supply chain information from the knowledgeable users to include in the supply chain risk report.

In one embodiment, an apparatus includes an identifying module that identifies selected users, where the selected users have an awareness of factors that potentially affect a supply chain. The apparatus includes a survey module that administers a supply chain screening survey to the selected users and receives survey answers from the selected users. The supply chain screening survey includes groups of intercorrelated questions. The apparatus includes an analytics module that performs a modified Cronbach-alpha analysis on the survey answers from the selected users in order to generate response consistency ratings for each of the selected users. The modified Cronbach-alpha analysis includes determining, for each one of the selected users, consistency between selected users of the survey answers within each group of intercorrelated questions.

The apparatus includes a user communication module that communicates with knowledgeable users of the selected users in order to generate a supply chain risk report from each of the knowledgeable users. The knowledgeable users have a specific knowledge of circumstances that are potentially affecting the supply chain. The apparatus includes a supply chain risk assessment module that receives the supply chain risk report from each of the knowledgeable users and generates a supply chain risk assessment by weighing the supply chain risk report from each of the knowledgeable users with the reliability ranking assigned to each of the knowledgeable users.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for supply chain risk assessment in accordance with one embodiment of the present invention;

FIG. 2 is a schematic block diagram illustrating one embodiment of a supply chain apparatus in accordance with one embodiment of the present invention;

FIG. 3 is a schematic block diagram illustrating another embodiment of a supply chain apparatus in accordance with one embodiment of the present invention;

FIG. 4 is a schematic flow chart diagram illustrating one embodiment of a method for assessing the risk to a supply chain in accordance with one embodiment of the present invention;

FIG. 5 is a schematic flow chart diagram illustrating another embodiment of a method for assessing the risk to a supply chain in accordance with one embodiment of the present invention; and

FIG. 6 is a schematic flow chart diagram illustrating yet another embodiment of a method for assessing the risk to a supply chain in accordance with one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the modified order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

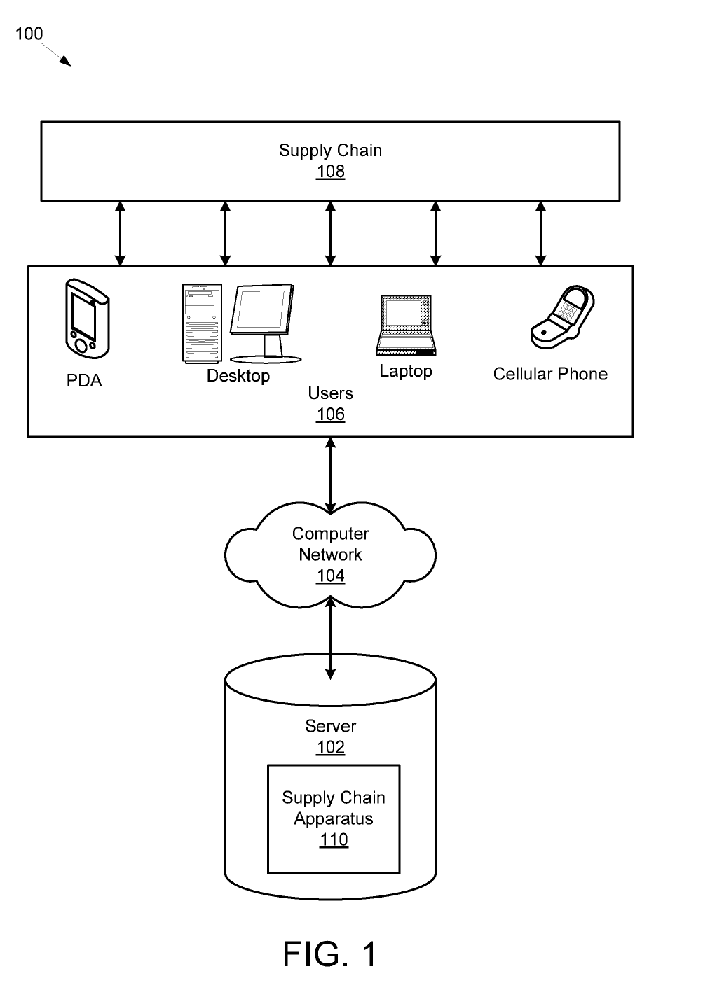

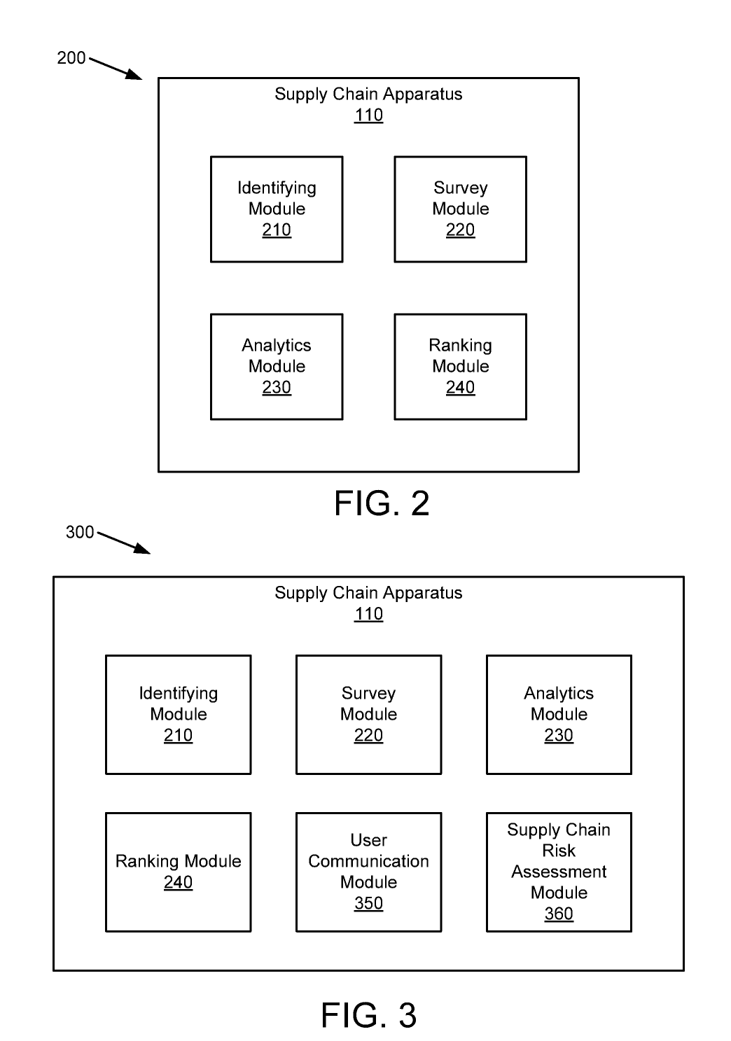

FIG. 1 is a schematic block diagram illustrating one embodiment of a system 100 for supply chain risk assessment in accordance with the present invention. The system 100 includes a server 102, a computer network 104, selected users 106, a supply chain 108, and a supply chain apparatus 110, which are described below. Generally and according to one embodiment, the supply chain apparatus 110 sends screening surveys to selected users 106 in order to determine the reliability of the selected users' 106 feedback regarding circumstances that may affect the supply chain 108. The supply chain apparatus 110 is described in greater detail below with reference to FIGS. 2 and 3.

The supply chain apparatus 110 may be part of a server 102, as shown, and may be accessible to the selected users 106 via electronic devices through a computer network 104 or may be installed on or accessible by a computing device, such as a desktop computer, workstation, laptop computer, tablet computer, a mobile computing device such as a cellular phone or smartphone, or any other computing device with access to a computer network 104. In one embodiment, the computing device facilitates a selected user 106 accessing the supply chain apparatus 110 by way of the server 102. In another embodiment, the computing device includes all or a portion of the supply chain apparatus 110 and accesses information located on the server 102. The server 102 may be part of a cloud computing environment accessible by the computing device. One of skill in the art will recognize other ways of implementing the supply chain apparatus 110 for user access using a computing device.

The computer network 104 may be a single network or may include several computer networks 104 linked together. The computer network 104 may include a local area network (“LAN”), wide area network (“WAN”), wireless network, etc. and may include a combination of networks. The computer network 104 may include hardware such as the server 102, routers, switches, cabling, and other communication hardware. Web pages available to the supply chain apparatus 110 may be located within a proprietary computer network 104, such as within one or more servers 102, one or more web servers, etc. of a company or may be located external to a proprietary computer network 104 and may be available for public access. In various embodiments, web pages may include information about the supply chain and/or about current events. One of skill in the art will recognize other content and web pages available for access by the supply chain apparatus 110 over one or more computer networks 104.

Generally, the system 100 is configured to allow selected users 106 to interact with the supply chain apparatus 110 via computing devices that communicate with a server 102 via a computer network 104. Crowd sourcing, in one embodiment, may be used to interact with people that may have some knowledge that would assist in identifying and/or commenting on factors that may affect a supply chain 108. Crowd sourcing may be used to identify individuals willing to participate in supply chain analysis and then the supply chain apparatus 110 may be used to determine selected users 106 and/or to determine weighting factors to be applied to the selected users 106. As described in greater detail below, the supply chain apparatus 110 identifies selected users 106 that have an awareness of factors that potentially affect a supply chain 108, administers a survey to examine the reliability of the selected users 106, and ranks the reliability of the selected users 106 based on their survey answers to the survey questions. The pool of potential selected users, in one embodiment, is identified through social media and other sources. As depicted in FIG. 1, the selected users 106 have at least some degree of access to or influence over the supply chain 108. A supply chain 108 is a system of resources (e.g., people, companies, activities, processes, equipment) that are involved with supplying a customer with a product or a service.

In order to maintain a functioning supply chain 108, events and circumstances should be assessed in order to determine if the events and circumstances pose a risk to the supply chain 108. In one embodiment, the selected users 106 themselves are part of the supply chain 108 (or at least directly involved with the supply chain 108). Accordingly, the supply chain apparatus 110 implements a reliability analysis on selected users 106 in order to determine the trustworthiness of supply chain related feedback from the selected users 106. In one embodiment, once the feedback from the selected users 106 has been analyzed for reliability, the feedback may be used in order to determine what preventative and/or remedial actions need to be performed in order to reduce vulnerability and ensure supply chain continuity.

For example, the selected users 106 in one embodiment may be employees of a company stationed at a certain locale. Such selected users 106 would have a location awareness relating to any events or circumstances that may potentially affect the supply chain 108 of the company. In another embodiment, the selected users 106 may include managers or executives of the company that have an understanding of and a degree of control over the operations of the supply chain 108. Thus, the selected users 106 may be any person that has an awareness (not necessarily knowledge) of factors that potentially affect a supply chain 108.

As discussed briefly above, the selected users 106 may interact and communicate with the supply chain apparatus 110 via various electronic devices that have access to a computer network 104. In one embodiment, a selected user may download an application (“App”) onto a phone which functions as the supply chain apparatus 110 or a selected user 106 may visit a website via the computing device. The website may be an independent website for administering a screening survey to the selected users 106 and/or receiving feedback from the selected users 106 regarding circumstances affecting the supply chain 108. The website may be a third-party social media website such as Facebook®, Twitter®, MySpace®, and the like. In another embodiment, the supply chain apparatus 110 interacts with selected users 106 via Short Message Service (“SMS”) text messaging, email, or phone calls. In one embodiment, the selected users may register and set up an account on the server 102 and create a user profile.

FIG. 2 is a schematic block diagram illustrating an apparatus 200 with one embodiment of the supply chain apparatus 110 in accordance with one embodiment of the present invention. The supply chain apparatus 110 includes an identifying module 210, a survey module 220, an analytics module 230, and a ranking module 240.

The identifying module 210 identifies selected users 106 that have an awareness of factors that potentially affect a supply chain 108. As described above, the selected users 106 in one embodiment may use crowd sourcing techniques. For example, the selected users 106 may come from a pool of potential users identified on a social media website, may be from one or more groups related to the supply chain 108, etc. In one embodiment, the selected users 106 may be employees of a company stationed in a certain locale. Such selected users 106 would have a location awareness relating to any events or circumstances that may potentially affect the supply chain 108 of the company. In another embodiment, the selected users 106 may include managers or executives of the company that have an understanding of and a degree of control over the operations of the supply chain 108. In yet another embodiment, the users 106, instead of being employed by the company the runs the supply chain 108, may be observers, bystanders, technicians, scientists, news reporters, meteorologists, geologists, or employees of another company associated with the supply chain, among others. Thus, the selected users 106 may be any person that has an awareness (not necessarily knowledge) of factors that potentially affect a supply chain 108.

The survey module 220 then administers a supply chain screening survey to the selected users 106 and receives survey answers from the selected users 106. In one embodiment, the supply chain screening survey includes at least one group of intercorrelated questions. For the purposes of this disclosure, certain questions are deemed ‘intercorrelated’ if those certain questions are directed towards measuring the same construct or idea. In other words, questions directed towards measuring the respondents' (selected users 106) attitude and understanding regarding a specific subject matter would qualify as intercorrelated questions. Thus, each group of intercorrelated questions may relate to different subject matter. For example, one of the groups of intercorrelated questions may relate to the selected users' 106 awareness of factors that potentially affect the supply chain 108. Another group of intercorrelated questions may relate to the selected users' 106 degree of control over the factors that potentially affect a supply chain 108. In yet another embodiment, one of the groups of intercorrelated questions may relate to the selected users' 106 awareness of how potential factors can/do affect a supply chain 108. In such embodiments, the survey answers from the selected users 106 may be used to both gauge the consistency/reliability of the users and to receive feedback from the users regarding supply chain risk.

However, in other embodiments, the groups of intercorrelated questions need not relate to supply chain topics. For example, one of the groups of intercorrelated questions may relate to social media use or general awareness of current events. In another example, one of the groups of intercorrelated questions may relate to job performance, personal habits, or comprehension of various topics. Thus, according to one embodiment, the subject matter of each group of intercorrelated questions may vary. The subject matter of the groups of intercorrelated questions may vary because, as described below with reference to the analytics module 230, the survey answers received by the supply chain apparatus 110 to each group of intercorrelated questions are analyzed to determine the consistency and reliability of each of the selected users 106.

Further, in one embodiment the intercorrelated questions are scattered throughout the screening survey and are not arranged in an ordered fashion (e.g., under a topic heading). Thus, the intercorrelated nature of the questions may not be readily apparent to the selected users 106. In another embodiment, the intercorrelated questions may be grouped together in distinct, identified sets of questions, thus making the intercorrelated nature of the questions known to the selected users 106. In one example, the supply chain screening survey may have the following statements with instructions to mark each statement as strongly agree, agree, neutral, disagree, or strongly disagree:

1. You use a smartphone, tablet or other mobile device to communicate.
2. Your communications are affected if you are without your mobile device for a day.
3. You communicate with pictures, text messages or other social media tools.
4. You are a frequent user of mobile communication tools.
5. You regularly follow the news inside your country.
6. You regularly follow the news outside your country.
7. You listen to or follow news sources that originate from other parts of the world.
8. You use a smartphone, tablet or other mobile device to receive your news.
9. You regularly follow new events in business and politics.
10. You regularly express your opinion of these news events with others.
11. You share your opinion with others using a smartphone, tablet or other mobile device.
12. You are aware of global supply chains and the multi-tiered relationships between companies.
13. You are regularly involved in the management of supply chain operations and supply chain problem.
14. You are currently working in a position or profession related to supply chains.
15. You are regularly aware of events that affect supply chains.
16. You regularly hear news and think about the supply chain impacts.
17. You regularly share your opinion of events via social media to communicate supply chain risk.
18. You are able to distinguish and judge the potential magnitude of an event as it may relate to the supply chain.
19. You are already part of at team that shares information about upcoming or existing events and their supply chain impacts.
20. You would like to become part of a team to share supply chain risk information for the purpose of an early warning system.

The analytics module 230 performs a modified Cronbach-alpha analysis on the survey answers from the selected users in order to generate a response consistency rating for each of the selected users 106. In statistics, Cronbach's alpha is a coefficient used to represent the internal consistency of a test. Cronbach's alpha is a measure of how reliable a test or a survey is by comparing the test responses from a plurality of users. Cronbach's alpha is applicable to tests that have groups of intercorrelated questions (commonly referred to as “testlets” or tests within a test). The following equation is Cronbach's formula for determining alpha:

$$α = \frac{K}{K - 1} ( 1 - \frac{{\sum }_{i = 1}^{K} {σ}_{i}^{2}}{{σ}_{x}^{2}} )$$

wherein α is a coefficient with values between 0 and 1 (Cronbach's alpha),
K is the total number (sum) of testlets,
i represents the individual testlets,
σ_{yi}² is the variance of the scores for testlet i, and
σₓ² is the variance of all the scores from all the testlets

One step in solving for alpha (a) is summing the statistical variances of all the test answers (from a plurality of users) for each group of intercorrelated questions (testlets) and dividing that result into the statistical variance of all the test answers (from the plurality of users) for all the questions. In other words, the conventional Cronbach analysis involves assuming that the users are reliable and consistent in order to determine the reliability and consistency of the test. The present disclosure implements a modified Cronbach-alpha analysis, wherein the consistency and reliability of the test (supply chain screening survey) is assumed in order to determine the reliability and consistency of the users. For example, the modified Cronbach-alpha analysis may use the equation listed above while assuming that the questions are valid and then calculating an alpha for each user or group of users. While various statistical metrics can be implemented to measure the reliability and consistency of the survey answers from the selected users 106, in one embodiment standard deviation and/or statistical variance is used to measure the reliability of the selected users' 106 survey answers.

In one embodiment, the modified Cronbach-alpha analysis involves calculating the alpha coefficient from the formula above for various subgroups of the selected users 106. In other words, the survey answers from a first sub-group of the selected users 106 may generate an alpha coefficient that is relatively higher than a second sub-group of the selected users 106, thus signifying that the survey answers from the first sub-group are more reliable and/or more consistent than the survey answers from the second sub-group. In one embodiment, the modified Cronbach-alpha analysis performed by the analytics module 230 may include grouping users together depending on the number of matching survey answers. Thus, in one embodiment, the survey answers from one user of a group of users may be compared with the survey answers from other users of a group of users. For each of the other users in the group of users, the analytics module 230 determines the number of survey answers that match the survey answers of the one user. Depending on a predetermined ‘matching threshold’ (i.e., a minimum percentage of individual survey answers from each one of the other users that match the individual survey answers from the one user, e.g., 50%), the analytics module 230 can generate a response consistency rating for the one user that includes the number of the other users whose survey answers meet the ‘matching threshold’. The analytics module 230 can then proceed to perform a similar matching analysis for each of the users in the group of users.

In another embodiment, the analytics module 230 reviews each of the selected user's survey answers within each group of intercorrelated questions. Depending on the level and degree of consistency of the survey answers between the questions within each group of intercorrelated questions, a response consistency rating is generated. For example, if one of the selected users 106 answers each of the questions in a group of intercorrelated questions in a consistent manner, the response consistency rating generated by the analytics module 230 for that particular user would be higher than another user that didn't answer the questions in a consistent manner. In order to more accurately describe the analytics module 230 and the modified Cronbach-alpha analysis that is performed on the survey answers from the selected users 106, the following hypothetical example is included in the disclosure.

### Example

A group of 19 users may have been identified through crowd sourcing and were given the same supply chain screening survey. The survey, for example, may include the 20 questions listed above. with the instructions that the users should enter the number “1” for statements that they “strongly agreed” with, the number “2” for statements that they “agree” with, the number “3” for statements about which they are “neutral”, the number “4” for statements that they “disagreed” with, and the number “5” for statements that they “strongly disagreed” with. For clarity and conciseness, the users' survey answers are included below in Table 1:

TABLE 1

| | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| P1 | 1 | 1 | 1 | 2 | 1 | 2 | 3 | 1 | 2 | 3 | 4 | 1 | 2 | 1 | 1 | 1 | 3 | 1 | 1 | 1 |
| P2 | 4 | 4 | 2 | 4 | 1 | 1 | 2 | 4 | 1 | 3 | 5 | 1 | 3 | 1 | 1 | 1 | 4 | 2 | 3 | 2 |
| P3 | 5 | 2 | 2 | 3 | 1 | 3 | 2 | 5 | 2 | 4 | 5 | 1 | 2 | 1 | 3 | 2 | 4 | 3 | 2 | 2 |
| P4 | 1 | 1 | 1 | 1 | 1 | 2 | 3 | 1 | 1 | 4 | 4 | 2 | 4 | 2 | 3 | 2 | 5 | 4 | 4 | 4 |
| P5 | 5 | 5 | 5 | 5 | 2 | 4 | 4 | 5 | 3 | 3 | 5 | 1 | 3 | 1 | 3 | 3 | 5 | 2 | 3 | 2 |
| P6 | 1 | 1 | 1 | 1 | 1 | 2 | 2 | 1 | 2 | 3 | 3 | 1 | 1 | 1 | 1 | 1 | 3 | 1 | 1 | 1 |
| P7 | 2 | 2 | 2 | 3 | 2 | 2 | 2 | 2 | 2 | 2 | 4 | 2 | 4 | 2 | 2 | 3 | 4 | 3 | 4 | 4 |
| P8 | 1 | 1 | 1 | 1 | 1 | 1 | 1 | 1 | 1 | 1 | 1 | 1 | 2 | 1 | 1 | 1 | 2 | 1 | 3 | 3 |
| P9 | 1 | 2 | 1 | 1 | 2 | 3 | 4 | 1 | 1 | 2 | 4 | 1 | 4 | 1 | 3 | 2 | 4 | 4 | 5 | 4 |
| P10 | 1 | 2 | 1 | 1 | 1 | 2 | 3 | 1 | 1 | 3 | 4 | 1 | 1 | 1 | 1 | 1 | 4 | 2 | 1 | 3 |
| P11 | 1 | 1 | 1 | 1 | 1 | 2 | 1 | 2 | 1 | 2 | 3 | 1 | 2 | 1 | 1 | 1 | 3 | 2 | 1 | 1 |
| P12 | 4 | 4 | 2 | 4 | 1 | 2 | 2 | 4 | 2 | 3 | 4 | 1 | 1 | 1 | 2 | 2 | 4 | 2 | 2 | 2 |
| P13 | 2 | 2 | 2 | 1 | 2 | 2 | 2 | 3 | 3 | 3 | 4 | 1 | 2 | 1 | 2 | 2 | 3 | 2 | 2 | 1 |
| P14 | 3 | 2 | 2 | 4 | 1 | 1 | 1 | 2 | 1 | 4 | 4 | 2 | 5 | 3 | 4 | 3 | 5 | 4 | 4 | 4 |
| P15 | 1 | 2 | 2 | 1 | 2 | 2 | 3 | 1 | 2 | 5 | 5 | 1 | 1 | 1 | 2 | 2 | 3 | 2 | 1 | 3 |
| P16 | 1 | 1 | 1 | 1 | 2 | 4 | 4 | 2 | 3 | 4 | 4 | 1 | 1 | 1 | 2 | 3 | 5 | 2 | 2 | 2 |
| P17 | 2 | 3 | 2 | 2 | 2 | 3 | 4 | 3 | 2 | 4 | 5 | 1 | 2 | 2 | 3 | 3 | 5 | 3 | 3 | 4 |
| P18 | 3 | 4 | 5 | 4 | 1 | 1 | 2 | 5 | 1 | 2 | 5 | 1 | 1 | 1 | 1 | 1 | 1 | 2 | 1 | 2 |
| P19 | 1 | 1 | 1 | 1 | 2 | 2 | 2 | 2 | 1 | 3 | 4 | 2 | 1 | 1 | 2 | 2 | 2 | 1 | 2 | 3 |

In Table 1, the top row identifies the question number and the first column identifies each of the 19 selected users. The variance for each question may be calculated as follows in Table 2:

TABLE 2

| Q1 | Q2 | Q3 | Q4 | Q5 | Q6 | Q7 | Q8 | Q9 | Q10 | Q11 | Q12 | Q13 | Q14 | Q15 | Q16 | Q17 | Q18 | Q19 | Q20 |
|---|---|---|---|---|---|---|---|---|---|---|---|---|---|---|---|---|---|---|---|
| 2.10 | 1.58 | 1.47 | 2.03 | 0.26 | 0.81 | 1.04 | 2.26 | 0.56 | 0.94 | 0.94 | 0.18 | 1.62 | 0.32 | 0.89 | 0.65 | 1.36 | 0.98 | 1.58 | 1.26 |

The sum of the variances in Table 2 is 22.830. For each user, the answers may be totaled in Table 3.

TABLE 3

| P1 | P2 | P3 | P4 | P5 | P6 | P7 | P8 | P9 | P10 | P11 | P12 | P13 | P14 | P15 | P16 | P17 | P18 | P19 |
|---|---|---|---|---|---|---|---|---|---|---|---|---|---|---|---|---|---|---|
| 33.00 | 49.00 | 54.00 | 50.00 | 69.00 | 29.00 | 53.00 | 26.00 | 50.00 | 35.00 | 29.00 | 49.00 | 42.00 | 59.00 | 42.00 | 46.00 | 58.00 | 44.00 | 36.00 |

The mean for the answer totals in Table 3 is 46.00 and the variance is 132.54. From this information, the alpha is calculated as:

$$α = \frac{20}{19} ( 1 - \frac{22.83}{132.54} ) = 0.871$$

In one embodiment, consistency can be determined visually by summing for each of the 19 selected users the number of times for each question that a particular selected user has an answer that matches the answers from the other users. The matches are tallied in Table 4, which are results for selected user 6 (Person 6 or P6). Table 4 shows, for each user, the number of times selected 6 matched the particular selected user. For example, selected user 6 matched selected user 1 sixteen times, selected user 2 seven times, etc. Matches greater than 50% are shown in bold and selected user 6 matched other selected users more than 50% six times.

TABLE 4

| Appraiser | # Matched | Percent |
|---|---|---|
| Person1 | 16 | 80.00 |
| Person2 | 7 | 35.00 |
| Person3 | 5 | 25.00 |
| Person4 | 7 | 35.00 |
| Person5 | 3 | 15.00 |
| Person6 | 6 | |
| Person7 | 3 | 15.00 |
| Person8 | 11 | 55.00 |
| Person9 | 6 | 30.00 |
| Person10 | 13 | 65.00 |
| Person11 | 14 | 70.00 |
| Person12 | 8 | 40.00 |
| Person13 | 8 | 40.00 |
| Person14 | 1 | 5.00 |
| Person15 | 10 | 50.00 |
| Person16 | 7 | 35.00 |
| Person17 | 2 | 10.00 |
| Person18 | 8 | 40.00 |
| Person19 | 10 | 50.00 |

The same analysis is carried out for each selected user. Table 5 tabulates for each selected user the number of matches greater than 50%.

TABLE 5

| User | 1 | 2 | 3 | 4 | 5 | 6 | 7 | 8 | 9 | 10 | 11 | 12 | 13 | 14 | 15 | 16 | 17 | 18 | 19 |
|---|---|---|---|---|---|---|---|---|---|---|---|---|---|---|---|---|---|---|---|
| Matched | 4 | 2 | 1 | 1 | 1 | 6 | 0 | 4 | 2 | 7 | 4 | 3 | 3 | 0 | 3 | 2 | 0 | 1 | 4 |

As an example, if one group (Case A) includes selected users 1, 6, 8, 9, 10, 11, 15, and 19 and the remaining selected users 2, 3, 4, 5, 7, 12, 13, 14, 16, 17 and 18 are in a second group (Case B) and the selected users in Case A have a higher amount of agreement with other selected users than those of Case B. As can be seen from Table 5, selected users 6 and 10 have the highest count of matches with other selected users and also among themselves. Selected users 6 and 10 may be, from their personal point of view, using mobile technologies and social media, so in one embodiment all individual matches from selected user 6 and 10 were used to populate the group in Case A below. Tables 6 and 7 result. One of skill in the art will recognize that other methods may be used to group selected users.

TABLE 6
Case A

| | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| P1 | 1 | 1 | 1 | 2 | 1 | 2 | 3 | 1 | 2 | 3 | 4 | 1 | 2 | 1 | 1 | 1 | 3 | 1 | 1 | 1 |
| P6 | 1 | 1 | 1 | 1 | 1 | 2 | 2 | 1 | 2 | 3 | 3 | 1 | 1 | 1 | 1 | 1 | 3 | 1 | 1 | 1 |
| P8 | 1 | 1 | 1 | 1 | 1 | 1 | 1 | 1 | 1 | 1 | 1 | 1 | 2 | 1 | 1 | 1 | 2 | 1 | 3 | 3 |
| P9 | 1 | 2 | 1 | 1 | 2 | 3 | 4 | 1 | 1 | 2 | 4 | 1 | 4 | 1 | 3 | 2 | 4 | 4 | 5 | 4 |
| P10 | 1 | 2 | 1 | 1 | 1 | 2 | 3 | 1 | 1 | 3 | 4 | 1 | 1 | 1 | 1 | 1 | 4 | 2 | 1 | 3 |
| P11 | 1 | 1 | 1 | 1 | 1 | 2 | 1 | 2 | 1 | 2 | 3 | 1 | 2 | 1 | 1 | 1 | 3 | 2 | 1 | 1 |
| P15 | 1 | 2 | 2 | 1 | 2 | 2 | 3 | 1 | 2 | 5 | 5 | 1 | 1 | 1 | 2 | 2 | 3 | 2 | 1 | 3 |
| P19 | 1 | 1 | 1 | 1 | 2 | 2 | 2 | 2 | 1 | 3 | 4 | 2 | 1 | 1 | 2 | 2 | 2 | 1 | 2 | 3 |

TABLE 7
Case B

| | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| P2 | 4 | 4 | 2 | 4 | 1 | 1 | 2 | 4 | 1 | 3 | 5 | 1 | 3 | 1 | 1 | 1 | 4 | 2 | 3 | 2 |
| P3 | 5 | 2 | 2 | 3 | 1 | 3 | 2 | 5 | 2 | 4 | 5 | 1 | 2 | 1 | 3 | 2 | 4 | 3 | 2 | 2 |
| P4 | 1 | 1 | 1 | 1 | 1 | 2 | 3 | 1 | 1 | 4 | 4 | 2 | 4 | 2 | 3 | 2 | 5 | 4 | 4 | 4 |
| P5 | 5 | 5 | 5 | 5 | 2 | 4 | 4 | 5 | 3 | 3 | 5 | 1 | 3 | 1 | 3 | 3 | 5 | 2 | 3 | 2 |
| P7 | 2 | 2 | 2 | 3 | 2 | 2 | 2 | 2 | 2 | 2 | 4 | 2 | 4 | 2 | 2 | 3 | 4 | 3 | 4 | 4 |
| P12 | 4 | 4 | 2 | 4 | 1 | 2 | 2 | 4 | 2 | 3 | 4 | 1 | 1 | 1 | 2 | 2 | 4 | 2 | 2 | 2 |
| P13 | 2 | 2 | 2 | 1 | 2 | 2 | 2 | 3 | 3 | 3 | 4 | 1 | 2 | 1 | 2 | 2 | 3 | 2 | 2 | 1 |
| P14 | 3 | 2 | 2 | 4 | 1 | 1 | 1 | 2 | 1 | 4 | 4 | 2 | 5 | 3 | 4 | 3 | 5 | 4 | 4 | 4 |
| P16 | 1 | 1 | 1 | 1 | 2 | 4 | 4 | 2 | 3 | 4 | 4 | 1 | 1 | 1 | 2 | 3 | 5 | 2 | 2 | 2 |
| P17 | 2 | 3 | 2 | 2 | 2 | 3 | 4 | 3 | 2 | 4 | 5 | 1 | 2 | 2 | 3 | 3 | 5 | 3 | 3 | 4 |
| P18 | 3 | 4 | 5 | 4 | 1 | 1 | 2 | 5 | 1 | 2 | 5 | 1 | 1 | 1 | 1 | 1 | 1 | 2 | 1 | 2 |

Using the same process to calculate the alpha as for Table 1, the alpha for Case A is 0.84 and the alpha for Case B is 0.66. Thus the group in Case A has an alpha consistent with the alpha of all 19 users while the alpha of the group in Case B is lower. In one embodiment, using the group of Case A may be used instead of the group in Case B or responses from the group of Case A may be given a higher weight than the responses from the group in Case B. While a simple sorting based on number of exact matches was used to divide a larger group into sub-groups. Other methods of statistical analysis, such as standard deviation or ranges may also be used. For example, instead of an exact match, responses from a user may be matched to answers from another user based on a range. For example, if a user selected a 2 for a certain question, a match range may be 1-3 so if another user selects 3 for the same questions then this may be considered a match. Cronbach-Alpha may be used to gauge consistency of a group chosen by various statistical methods or by simple sorting.

The analytics module 230 may not necessarily analyze each user's response to each individual question, but instead may review each user's responses within each of the groups of intercorrelated questions. The questions above may be grouped into intercorrelated questions. While in the given example the comparative consistencies of the selected users are apparent upon visual inspection, statistical or mathematical models may be implemented to analyze the consistency of the survey answers.

As described above, the analytics module 230 does not necessarily have to implement a standard deviation calculation or a statistical variance calculation. Other statistical metrics or answer agreement analytics may be implemented to determine the variety and distribution of the survey answers within each group of intercorrelated questions. Further, the modified Cronbach-alpha analysis performed by the analytics module 230, according to one embodiment, may not involve the numbers 1-5, but other numbers may be involved that more accurately reflect and represent the selected users 106 response intent. Still further, the survey answers may not be easily represented by numbers but may instead be yes/no type answers or true/false type answers. Thus, while representing survey answers with numbers and using standard deviation and statistical variance as a metric for the reliability and consistency of the selected users 106 is perhaps a main embodiment, it is contemplated that other metrics and analytics can be performed by the analytics module 230 to generate the response consistency ratings.

The response consistency ratings may be generated for each one of the selected user's 106 survey answers to each group of intercorrelated questions. For example, if the supply chain screening survey had 5 groups of intercorrelated questions, according to one embodiment analytics module 230 may generate a response consistency rating for each group of intercorrelated questions. Continuing the example, each selected user 106 would then have 5 response consistency ratings. In another embodiment, the response consistency rating may be an average of the response consistency ratings from each of the groups of intercorrelated questions.

Once the analytics module 230 has generated the response consistency ratings for the selected users 106 (or at least a portion of the selected users 106), the ranking module 240 assigns a reliability rank to each of the selected users 106 based on their response consistency rating(s). In one embodiment, the reliability rank is a user classification category. For example, the ranking module 240 may include look-up tables or lists that sort selected users 106 into classification categories based on their response consistency ratings(s). The classification categories, in one embodiment, may be distinguishing the selected users 106 as either “reliable” or “unreliable”. In another embodiment, the reliability rank may include more than two classification categories (e.g., “very reliable”, “somewhat reliable”, etc.).

In yet another embodiment, the reliability rank includes a relative position in a listing of the selected users 106, wherein the relative position is based on the response consistency rating of each of the selected users. For example, the ranking module 240 can assign selected users 106 a position (reliability rank) in a list of other selected users 106, wherein the position is indicative of the selected users 106 reliability in comparison to the other selected users 106. In another embodiment, the reliability rank may include a numerical value that represents the weight or consideration that should be given to a selected user's 106 feedback. As briefly described above, the supply chain apparatus 110 is configured to identify selected users 106 and screen those selected users 106 so that any feedback, advice, reports, and/or recommendations regarding supply chain circumstances can be proportionally considered according to their respective reliability ranks. The supply chain apparatus 110, for example, may identify selected users 106 from a larger group than typical supply chain techniques and may then use the modified Cronbach-alpha analysis to identify selected users 106 with consistent responses while eliminating or minimizing responses from selected users 106 found to be inconsistent. Thus, certain embodiments of the supply chain apparatus 110 may use crowd sourcing to expand the number of people from which supply chain information is solicited while using techniques listed above get responses that may be more consistent and more useful than other supply chain information techniques.

FIG. 3 is a schematic block diagram illustrating another apparatus 300 with another embodiment of the supply chain apparatus 110 in accordance with one embodiment of the present invention. The supply chain apparatus 110 includes an identifying module 210, a survey module 220, an analytics module 230, and a ranking module 240, which are substantially similar described above with reference to the apparatus 200 of FIG. 2. The embodiment of the supply chain apparatus 110 depicted in FIG. 3 further includes a user communication module 350 and a supply chain risk assessment module 360, which are described below. Generally, the user communication module 350 and the supply chain risk assessment module 360 are configured to receive supply chain-related reports from a portion of selected users 106 and to assess the risk to the supply chain based on those reports, respectively. In other words, these two modules 350, 360 take the reliability rank generated in the ranking module 240 and apply the reliability rank to weigh actual feedback from people regarding risks to the supply chain.

The user communication module 350 communicates with a portion of the selected users 106 that have a specific knowledge of circumstances that are potentially affecting the supply chain. In other words, the user communication module 350 identifies certain users of the selected users 106 that have specific information regarding circumstances that are potentially affecting or will potentially affect the supply chain 108. Throughout the disclosure, the term “knowledgeable users” refers to the portion of the selected users 106 with whom the user communication module 350 of the supply chain apparatus 110 communicates in order to garner information regarding potential risks to the supply chain 108.

In one embodiment, the selected users 106 and the knowledgeable users are the same people. In another embodiment, the knowledgeable users are a subset of the selected users 106. In yet another embodiment, the knowledgeable users may not already by identified as selected users 106 and, therefore, the user communication module 350 can notify the identifying module 210 and the survey module 220 so that a supply chain screening survey can be sent to said user. In other words, the selected users 106 are identified as those people that have an awareness of factors that potentially affect the supply chain and the knowledgeable users are the certain selected users 106 that have specific knowledge of circumstances that are potentially affecting the supply chain. In one embodiment, the knowledgeable users may be the selected users 106 that received the comparatively higher reliability ranks from the ranking module 240.

The knowledgeable users communicate with the user communication module 350 so that information relating to risks to the supply chain 108 can be received by the user communication module 350 and compiled into supply chain risk reports. In one embodiment, the user communication module 350 engages in passive communication by, for example, monitoring social media information from the knowledgeable users. In another embodiment, the user communication module 350 engages in active communication via direct electronic contact with the knowledgeable users in order to actively solicit supply chain information from them. The supply chain risk reports include the supply chain information received from the knowledgeable users. In one embodiment, the supply chain risk reports may include information on weather, politics, geological conditions, inventory stockpiles, shipping status, personnel status, manufacturing conditions, current events, natural disasters, health and living conditions, etc. The supply chain risk reports may also include the knowledgeable users' opinions and/or recommendations regarding how the above circumstances affect or may affect the supply chain 108.

The supply chain risk assessment module 360 receives the supply chain risk reports from the knowledgeable users and generates a supply chain risk assessment by weighing the supply chain risk report from each of the knowledgeable users with the reliability ranking assigned to each of the knowledgeable users. As discussed above, even if the knowledgeable users are not originally included in the selected users 106, all the knowledgeable users should eventually participate in the supply chain screening survey so that their supply chain risk reports are accurately and proportionally considered in light of their reliability and credibility. The supply chain risk assessment module 360 takes the supply chain risk reports and proportionally considers the supply chain risk reports in light of the knowledgeable users reliability rank.

In one embodiment, the supply chain risk assessment module 360 only considers supply chain risk reports from the knowledgeable users that have a reliability rank above a certain threshold. In another embodiment, the supply chain risk assessment module 360 may consider all of the supply chain risk reports (or at least a certain portion of the supply chain risk reports), but gives more weight to the supply chain risk reports from the knowledgeable users that have a higher reliability rank.

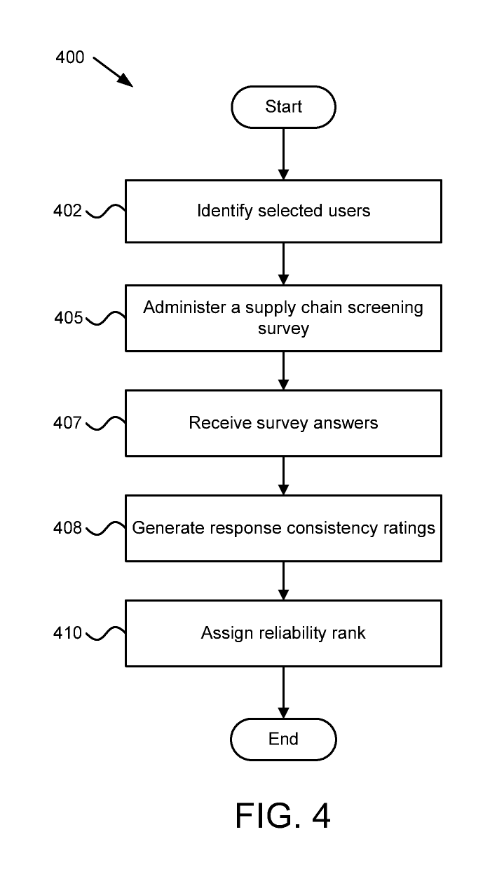

FIG. 4 is a schematic flow chart diagram illustrating one embodiment of a method 400 for assessing the risk to a supply chain 108 in accordance with one embodiment of the present invention. The method 400 includes identifying 402 selected users 106 that have an awareness of factors that may potentially affect a supply chain 108. These factors may include weather, politics, geological conditions, inventory stockpiles, shipping status, personnel status, manufacturing conditions, current events, natural disasters, health and living conditions, etc. The selected users 106 need only have an awareness of the factors and the selected users 106, in some embodiments, may not even know how the factors potentially affect a supply chain 108. Once the selected users 106 have been identified, the method 400 further includes administering 405 a supply chain screening survey to the selected users 106. The supply chain screening survey may be administered via a website, a social media application, direct electronic contact with the selected users 106, or some other comparable means. The supply chain screening survey includes groups of intercorrelated questions. The method 400 further includes receiving 407 the survey answers from the selected users 106.

The method 400 also includes generating 408 response consistency ratings by determining, for each one of the selected users 106, the consistency of the survey answers within each group of intercorrelated questions. As described above, if one of the selected users 106 answers each of the questions in a group of intercorrelated questions in a consistent manner, the response consistency rating generated by the analytics module 230 for that particular user would be higher than another user that didn't answer the questions in a consistent manner. After generating 408 response consistency ratings for the selected users 106, the method 400 includes assigning 410 a reliability rank to the selected users based on their response consistency ratings.

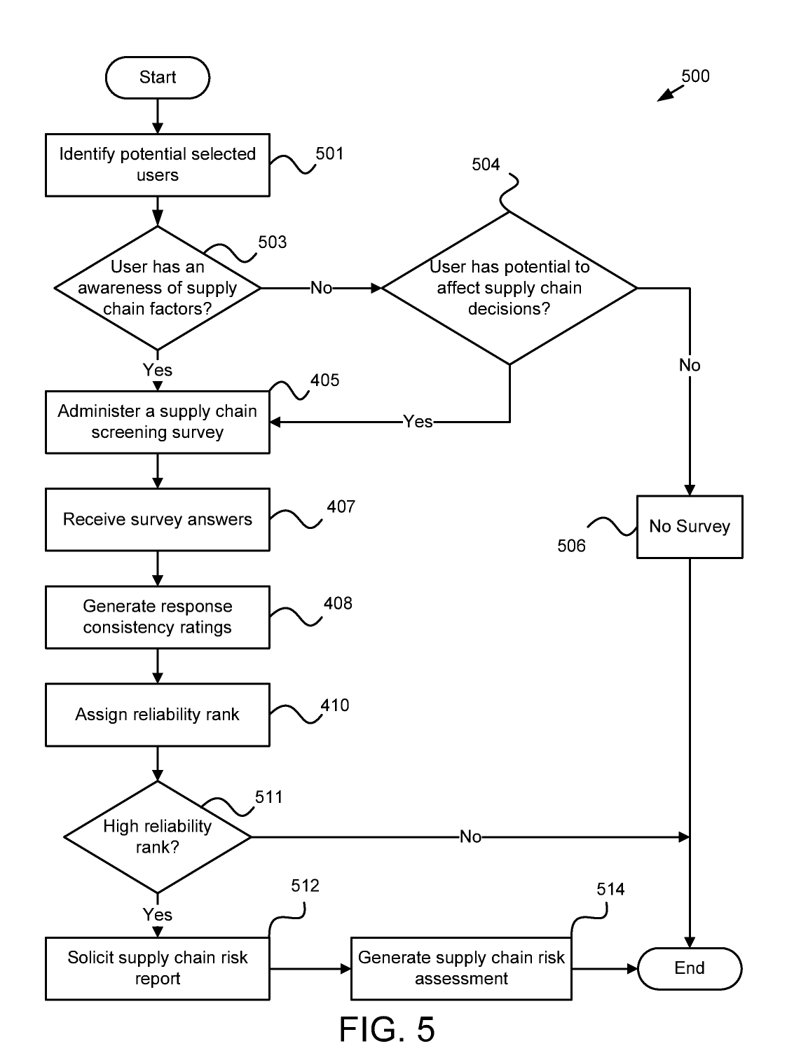

FIG. 5 is a schematic flow chart diagram illustrating another embodiment of a method 500 for assessing the risk to a supply chain 108 in accordance with one embodiment of the present invention. The method 500 depicted in FIG. 5 starts and identifies 501 potential selected users. The method 500 determines 503 if a potential selected user has an awareness of supply chain factors. If the method 500 determines 503 that the potential selected user does not have an awareness of supply chain factors, the method 500 determines 504 if the potential selected user has potential to affect supply chain decisions. If the method 500 determines 504 that the potential selected user does not have potential to affect supply chain decisions, the method 500 does not administer 506 a screening survey to the potential selected user, and the method 500 ends for the potential selected user.

If the method 500 determines 503 that the potential selected user has an awareness of supply chain factors or determines 504 that the potential selected user has potential to affect supply chain decisions, the user is a selected user 106 the method 500 continues and administers 405 a supply chain screening survey to the selected user 106 and subsequently receives 407 survey answers. Once the method 500 has received 407 survey answers from the selected users 106, the method 500 generates 408 response consistency ratings for the selected users 106 by determining, for each one of the selected users 106, the consistency of the survey answers within each group of intercorrelated questions. As described above, if a selected users 106 answers each of the questions in a group of intercorrelated questions in a consistent manner, the response consistency rating generated by the analytics module 230 for that particular selected user 106 would be higher than another selected user 106 that didn't answer the questions in a consistent manner. After generating 408 response consistency ratings for the selected users 106, the method 500 assigns 410 a reliability rank to the selected users 106 based on their response consistency ratings.

In the depicted embodiment, the method 500 determines 511 if a selected user 106 has a high reliability rank so that supply chain risk reports can be generated. If the method 500 determines 511 that a selected user 106 does not have a high reliability rank, the selected user 106 is not solicited for supply chain information. If the method 500 determines 511 that a selected user 106 has a high reliability rank, the method 500 solicits 512 the selected user 106 for a supply chain risk report. The solicitation 512 may be active or passive, as described above with reference to FIG. 3. Once method 500 has solicited 512 supply chain risk reports from the selected users 106 with a high reliability rank and the supply chain risk reports have been received from the selected users 106 with the high reliability ranks, the method 500 generates 514 a supply chain risk assessment, and the method 500 ends. The supply chain risk assessment may include a recommendation for preventative or remedial action in order to maintain functionality of or limit vulnerability to the supply chain 108.

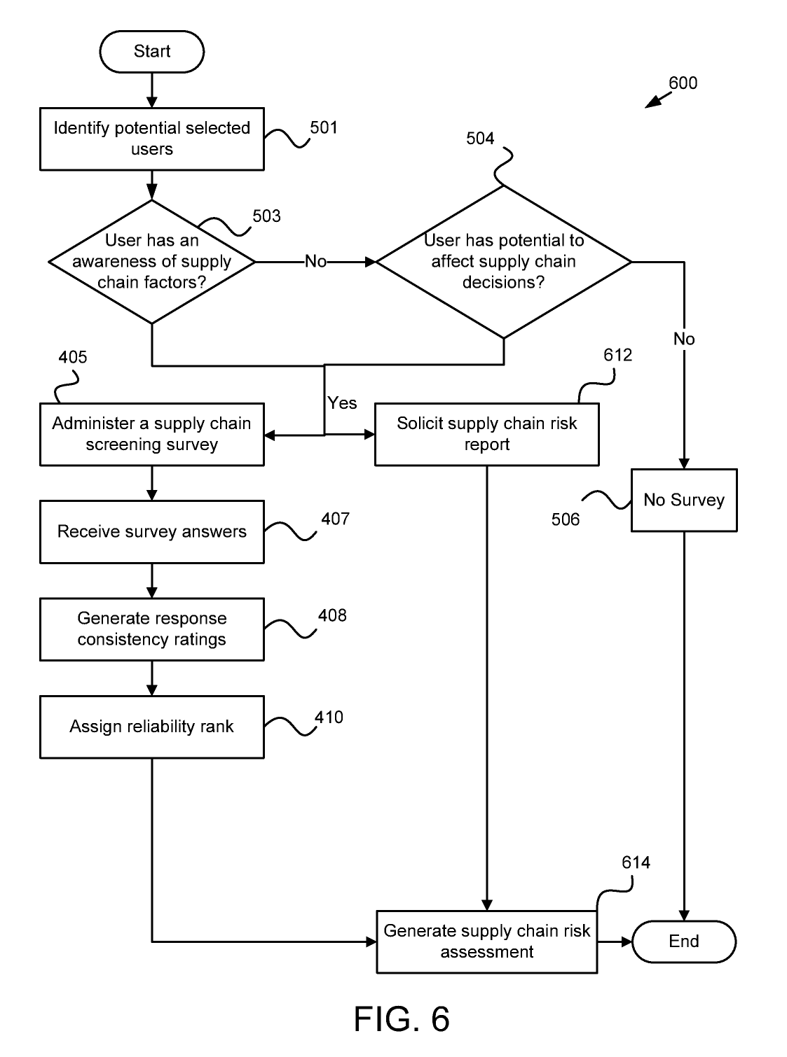

FIG. 6 is a schematic flow chart diagram illustrating yet another embodiment of a method 600 for assessing the risk to a supply chain 108 in accordance with one embodiment of the present invention. The method 600 starts and identifies selected users 106 by, identifying 501 potential selected users, determining 503, 504 if the potential selected users have an awareness of supply chain factors or have potential to affect supply chain decisions as in the method 500 of FIG. 5. The method 600 then solicits 612 a supply chain risk report from identified selected users 106 at substantially the same time when the method 600 administers 405 the supply chain screening survey. The method 600 then continues in substantially the same manner as described above with reference to FIG. 5 up until the step of assigning 410 the reliability rank.

After the reliability ranks have been assigned 410 to the selected users 106, the method 600 includes generating 614 a supply chain risk assessment by considering all of the supply chain risk reports from all of the selected users 106 by factoring in the reliability rankings of the selected users 106, and the method 60 ends. In one embodiment, generating 614 the supply chain risk assessment includes sequentially considering the supply chain risk reports from the selected users 106 according to their respective reliability rank. In other words, the supply chain risk reports from the most reliable users may be considered first. In another embodiment, the method 600 includes supply chain risk reports from selected users 106 with a reliability ranking over a certain threshold.

In another embodiment, generating 614 the supply chain risk assessment includes weighing each of the supply chain risk reports from the selected users 106 with the reliability rank assigned to each of the selected users 106. In another embodiment, the method 600 the method 600 includes supply chain risk reports from selected users 106 with a reliability ranking over a certain threshold and weighs each of the supply chain risk reports from the selected users 106 based on the reliability rank assigned to each of the selected users 106.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an identifying module that identifies selected users, wherein the selected users have an awareness of factors that potentially affect a supply chain;
a survey module that administers a supply chain screening survey to the selected users and receives survey answers from the selected users, wherein the supply chain screening survey comprises at least one group of intercorrelated questions;
an analytics module that performs a modified Cronbach-alpha analysis on the survey answers from the selected users in order to generate a response consistency rating for each of the selected users, wherein the modified Cronbach-alpha analysis comprises determining, for each one of the selected users, consistency between selected users of the survey answers within each group of intercorrelated questions; and
a ranking module that assigns a reliability rank to each of the selected users based on the response consistency rating for each of the selected users,
wherein at least a portion of the identifying module, the survey module, the analytics module, and the ranking module comprise one or more of hardware and executable code, the executable code stored on one or more computer readable storage media.

2. The apparatus of claim 1, further comprising:
a user communication module that communicates with knowledgeable users of the selected users in order to generate a supply chain risk report from each of the knowledgeable users, wherein the knowledgeable users have a specific knowledge of circumstances that are potentially affecting the supply chain; and
a supply chain risk assessment module that receives the supply chain risk report from each of the knowledgeable users and generates a supply chain risk assessment by weighing the supply chain risk report from each of the knowledgeable users with the reliability rank assigned to each of the knowledgeable users.

3. The apparatus of claim 2, wherein the user communication module communicates with the knowledgeable users via a social media application.

4. The apparatus of claim 2, wherein the selected users with a comparatively higher reliability rank comprise the knowledgeable users.

5. The apparatus of claim 2, wherein the specific knowledge of the knowledgeable users comprises physical proximity to the circumstances that are potentially affecting the supply chain.

6. The apparatus of claim 2, wherein the supply chain risk assessment comprises a recommendation regarding a course of action to take in order to sustain the supply chain.

7. The apparatus of claim 1, wherein the selected users are employees of a company.

8. The apparatus of claim 1, wherein the supply chain screening survey is administered via a social media application.

9. The apparatus of claim 1, wherein the groups of intercorrelated questions are selected from the group comprising:
awareness of factors that potentially affect a supply chain;
degree of control over factors that potentially affect a supply chain; and
awareness of how potential factors can affect a supply chain.

10. The apparatus of claim 1, wherein the modified Cronbach-alpha analysis comprises determining the statistical variance of the survey answers from each selected user for each group of intercorrelated questions.

11. The apparatus of claim 10, wherein the response consistency rating for each selected user comprises an average of the statistical variances from the groups of intercorrelated questions.

12. The apparatus of claim 1, wherein the response consistency rating comprises a percentage of questions answered consistently for each group of intercorrelated questions.

13. The apparatus of claim 1, wherein the response consistency rating one or more of:
comprises an average percentage of questions answered consistently; and
is based on a number of users that reported survey answers that satisfied a matching threshold.

14. The apparatus of claim 1, wherein the reliability rank comprises a classification as either reliable or unreliable.

15. The apparatus of claim 1, wherein the reliability rank comprises a relative position in a listing of the selected users, wherein the relative position is based on the response consistency rating of each of the selected users.

16. A method comprising:
identifying selected users that have an awareness of factors that potentially affect a supply chain;
administering a supply chain screening survey to the selected users, wherein the supply chain screening survey comprises groups of intercorrelated questions;
receiving survey answers from the selected users;
performing a modified Cronbach-alpha analysis on the survey answers from the selected users in order to generate a response consistency rating for each of the selected users, wherein the modified Cronbach-alpha analysis comprises determining, for each one of the selected users, consistency between selected users of the survey answers within each group of intercorrelated questions; and
assigning a reliability rank to each of the selected users based on the response consistency ratings for each of the selected users.

17. The method of claim 16, wherein identifying selected users is performed via a social media application.

18. The method of claim 16, the method further comprising:
communicating with knowledgeable users from the selected users in order to generate a supply chain risk report from the knowledgeable users, wherein the knowledgeable users have a specific knowledge of circumstances that are potentially affecting the supply chain; and
generating a supply chain risk assessment by weighing the supply chain risk report from each of the knowledgeable users with the reliability rank assigned to each of the knowledgeable users.

19. The method of claim 18, further comprising actively soliciting supply chain information from the knowledgeable users to include in the supply chain risk report.

20. An apparatus comprising:
an identifying module that identifies selected users, wherein the selected users have an awareness of factors that potentially affect a supply chain;
a survey module that administers a supply chain screening survey to the selected users and receives survey answers from the selected users, wherein the supply chain screening survey comprises groups of intercorrelated questions;
an analytics module that performs a modified Cronbach-alpha analysis on the survey answers from the selected users in order to generate response consistency ratings for each of the selected users, wherein the modified Cronbach-alpha analysis comprises determining, for each one of the selected users, consistency between selected users of the survey answers within each group of intercorrelated questions;
a ranking module that assigns a reliability rank to each of the selected users based on the response consistency ratings for each of the selected users;
a user communication module that communicates with knowledgeable users of the selected users in order to generate a supply chain risk report from each of the knowledgeable users, wherein the knowledgeable users have a specific knowledge of circumstances that are potentially affecting the supply chain; and
a supply chain risk assessment module that receives the supply chain risk report from each of the knowledgeable users and generates a supply chain risk assessment by weighing the supply chain risk report from each of the knowledgeable users with the reliability rank assigned to each of the knowledgeable users;
wherein at least a portion of the identifying module, the survey module, the analytics module, the ranking module, the user communication module, and the supply chain risk assessment module comprise one or more of hardware and executable code, the executable code stored on one or more computer readable storage media.
